(19) United States
(12) Patent Application Publication
(10) Pub. No.: US 2008/0170386 A1
(43) Pub. Date: Jul. 17, 2008

(54) Wiring method and design for light fixture

(75) Inventor: Stefan Albrecht Dag, Carbondale, CO (US)

Correspondence Address: EVA ALEXANDRA ANWYL-DAVIES DAG, 0848 COUNTY ROAD 106, CARBONDALE, CO, 81623, US

(73) Assignee: CANDELIERART.COM BY STEFAN DAG

(21) Appl. No.: 11/654,044

(22) Filed: Jan. 17, 2007

(51) Int. Cl. F21S 8/00

(52) U.S. Cl. 362/145

(57) ABSTRACT

Take three sheets of any material. Sheets can be cut into any shape, utilizing any shape. In middle sheet cut out channels/slots/plenum to accommodate electrical wiring. In top sheet cut out holes through which wiring will be threaded from one electrical connection to another. Holes allow access to wiring and allowing wires to be connected to the electrical support for each light/light bulb. Sandwich all three sheets together to create a rigid platform. Dependent on material selected, grounding of circuitry may be required through alternate means. Cut out holes in lower sheet to accommodate optional [amended 6/29/2007] downward facing light on a separate circuit.

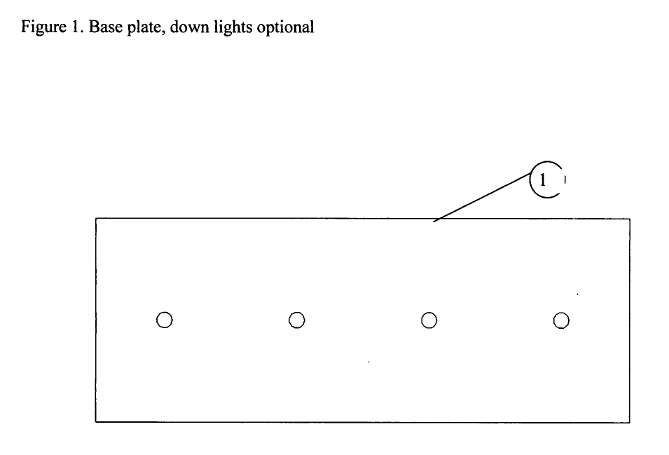

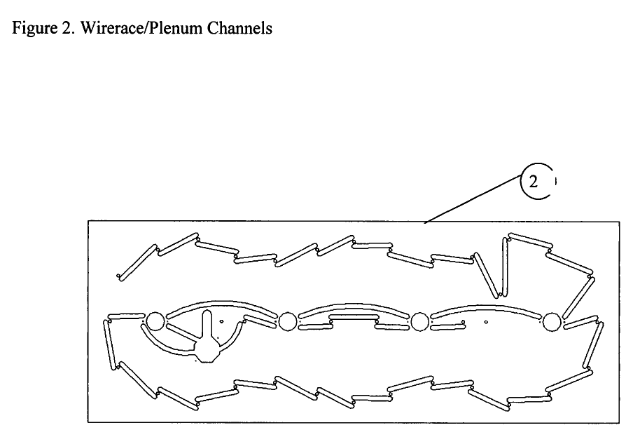

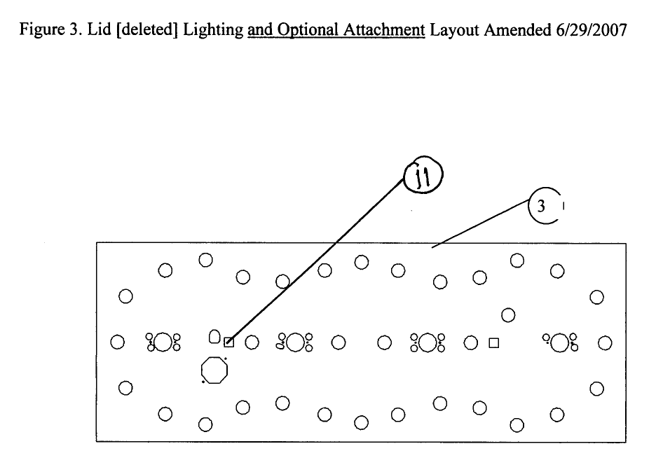

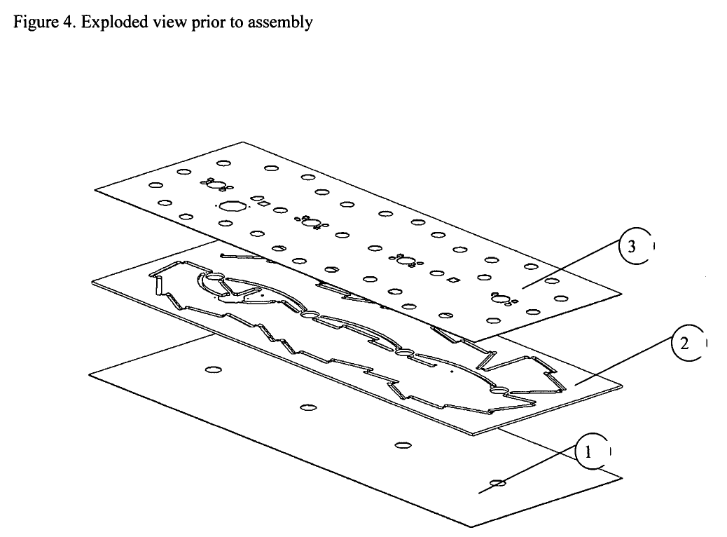

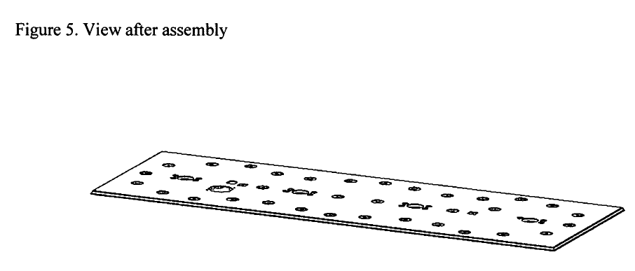

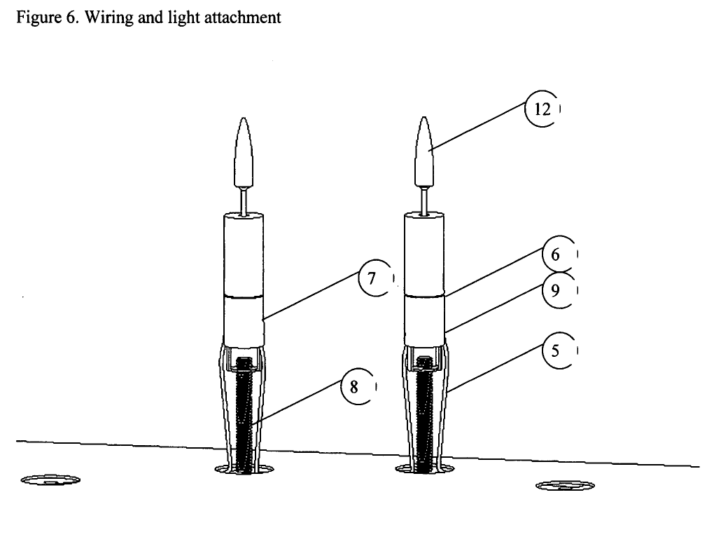

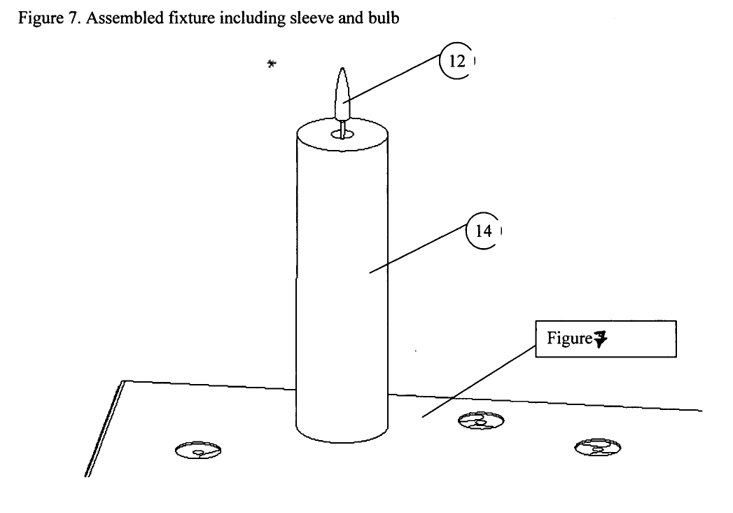

### COMPONENTS

(1) Plate/Sheet ONE made of solid any material
Such as but not limited to: Steel, metal, mica, stainless steel, aluminum, iron, polycarbonate
(2) Plate/Sheet TWO made of any solid material to appropriate thickness to maintain rigidity Such as but not limited to: Steel, metal, mica, stainIs steel, aluminum, iron, polycarbonate
(3) Plate/Sheet THREE
Such as but not limited to: Steel, metal, mica, stainless steel, aluminum, iron, polycarbonate
(4) Glue - Glues appropriate adhesive to glue both materials used in ONE to adhere to plate/sheet TWO and appropriate adhesive to glue both materials used in TWO to adhere to plate/sheet THREE
(5) Electrical wires (positive and ne tive)
(6) Electrical connectors
(7) Light Socket
(8) Nipple
(9) Insulators
(10) Junction box
(11) Extensions
(12) Feeling's me light bulb(s)
(13) Downward lighting
(14) Holl housing/sleeve made of any of the following but not limited to: Pillar Wax, resin, nylon, glass
(15) Junction Box

### DESIGN AND METHOD

How to make a slim line platform for electrical wiring to produce a lighting fixture with the option of but including feelings flame light bulbs

### SPECIFICATIONS

FIG. #1. Lid and light layout

FIG. #2. Center with plenum/channels cut out

FIG. #3. Base with optional holes for optional down lights

FIG. #4. Explosed view of lid, center and base

FIG. #5. Unified view of lid, center and base

FIG. #6. Electrical wiring view with light buld (optional use of feeling's flame light bulb)

1. A light fixture held in suspended position or optionally placed on a flat surface, said fixture comprising of:
three individual plates, fabricated of rigid material, fabricated in such a manner to create a stiff assembly incorporating a wire race plenum, joined together to form a stiff platform.
attachment points required for individual light sockets form part of the assembly optional attachment points for suspending fixture from overhead, allow exit point(s) for wire connection to line voltage.
provide means of grounding to structure, light attachment point and grounded circuit.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)
